(19) United States
(12) Patent Application Publication
(10) Pub. No.: US 2010/0185957 A1
(43) Pub. Date: Jul. 22, 2010

(54) PARTICIPANT RESPONSE SYSTEM EMPLOYING GRAPHICAL RESPONSE DATA ANALYSIS TOOL

(76) Inventors: Taco Van Ieperen, Calgary (CA); Michael Boyle, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/522,844

(22) PCT Filed: Jan. 10, 2008
(86) PCT No.: PCT/CA2008/000037

§ 371 Date: Feb. 25, 2010

Related U.S. Application Data
(60) Provisional application No. 60/879,572, filed on Jan. 10, 2007.

(51) Int. Cl. G06F 3/01; G06F 3/048

(52) U.S. Cl. 715/753; 715/810

(57) ABSTRACT

A participant response system (50) comprises processing structure (52) running an assessment during which participants are prompted to respond to one or more information requests and a plurality of remote units (62) communicating with the processing structure. The remote units are used by participants to input responses to information requests and convey received response data to the processing structure. The processing structure (52) executes a graphical response data analysis tool that processes received response data thereby to generate response performance data in differing levels. At least one display device (52, 70) communicates with the processing structure and is operable to display graphically the response performance data in one or more of the differing levels.

### RELATED APPLICATIONS

This application claims the benefit of U.S. Provisional Patent Application Ser. No. 60/879,572 to Van Ieperen et al. filed on Jan. 10, 2007 entitled “Participant Response System Employing Graphical Response Analysis Tool”, the content of which is incorporated herein by reference.

### FIELD OF THE INVENTION

The present invention relates generally to a participant response system and in particular to a participant response system employing a graphical response data analysis tool.

### BACKGROUND OF THE INVENTION

Participant response systems for enabling participants of an event to enter responses to posed questions, motions or the like are well known in the art and have wide applicability. For example, during a conference, seminar or the like, participants can be provided with handsets that enable the participants to respond to questions, or to vote on motions raised during the conference or seminar. In the entertainment field, audience members can be provided with handsets that enable the audience members to vote for entertainment programmes or sporting events. These participant response systems are also applicable in the field of education. Students can be provided with handsets that enable the students to answer questions posed during lessons, tests or quizzes. Of significant advantage, these participant response systems provide immediate feedback to presenters, teachers, entertainment programme producers, or event organizers. With respect to the field of education, research shows that teachers teach better and students learn better when there is rapid feedback concerning the state of students' comprehension or understanding. It is therefore not surprising that such participant response systems are gaining wide acceptance in the field of education.

Participant response systems fall generally into two categories, namely wired and wireless participant response systems. In wired participant response systems, the remote units used by participants to respond to posed questions or to vote on motions are typically physically connected to a local area network and communicate with a base or host computer. In wireless participant response systems, the remote units used by participants to respond to posed questions or to vote on motions communicate with the host computer via wireless communication links. Whether wired or wireless, many different types of participant response systems have been considered.

For example, U.S. Pat. No. 2,465,976 to Goldsmith discloses a centercasting network system for polling public opinion by means of radio apparatus installed in numerous outlying voting stations. Groups of outlying voting stations communicate with associated central stations where votes that are obtained by the voting stations are counted or tabulated in accordance with any desired classification of votes. The voting stations gather and store voters' choices in a tangible medium. All of the voting stations within a given group then transmit the stored votes sequentially to the central station that serves the particular group. The total votes are stored at each central station until a master station transmits a start signal to the central station. The central station then transmits the results to the master station sequentially.

U.S. Pat. No. 3,858,212 to Tompkins et al. discloses a multi-purpose information gathering and distribution system comprising a central station having an omni-directional antenna for transmitting information queries to a plurality of remote stations and for gathering data acquired at the remote stations that is returned to the central station by the remote stations in response to the information queries. The remote stations are sequentially queried by the central station. In response to the information query, each remote station transmits the conditions at the remote station together with a remote identification code to the central station.

U.S. Pat. No. 4,247,908 to Lockhart, Jr et al. discloses a two-way communication system for use with a host computer that includes a control unit, a base station and multiple, hand-held, portable radio/data terminal units. The control unit interfaces directly with the host computer but uses a radio link to interface with the portable radio/data terminal units. Each portable radio/data terminal unit includes a two-way radio and a data terminal. The data terminal includes a keyboard for data entry and an LED display for readout of either received data or locally generated data. The host computer initiates communication through polling and/or selection of portable radio/data terminal units via the control unit. The control unit, in response to a “poll” from the host computer, answers by sending either a previously received message from a portable radio/data terminal unit, or if no message has been received, a “no message” response. Polling by the control unit is an invitation to the portable radio/data terminal units to send data to the control unit to be stored, grouped if necessary and sent on to the host computer. The control unit polls the portable radio/data terminal units by address in a particular sequence. The control unit transmits acknowledgements to the portable radio/data terminal units for received data on the next polling cycle.

U.S. Pat. No. Re. 35,449 to Derks discloses a remote response system comprising a central control unit that transmits a plurality of distinct address words to remotely located response units and a receiver that receives data words transmitted from response units. Each response unit includes user operable data entry means and a receiver for receiving address words transmitted from the central control unit. Each response unit also includes circuit means for identifying an address word unique to the particular response unit and a transmitter for transmitting data words to the central control unit in response to identification of its unique address word. The central control unit comprises means for determining that a valid data word has been received from a response unit and for transmitting an acknowledge message to the response unit that sent the valid word. In response to the received acknowledge message, the particular response unit is conditioned to a second, or “off”, mode. When a response unit has been placed in the “off” mode, the response unit will not respond to its address word again until a new user selection is made.

U.S. Pat. No. 5,002,491 to Abrahamson et al. discloses an interactive electronic classroom system for enabling teachers to teach students concepts and to receive immediate feedback regarding how well the students have learned the taught concepts. Structure is provided for enabling students to proceed in lockstep or at their own pace through exercises and quizzes, responding electronically to questions asked, the teacher being able to receive the responses, and to interpret a readout of student responses in histogram or other graphic display form. The electronic classroom comprises a central computer and a plurality of student computers, which range from simple devices to full fledged personal computers, connected to the central computer over a network. Optional peripheral hardware, such as video cassette recorders (VCRs) or other recording/reproducing devices, may be used to provide lessons to students in association with the computer network.

U.S. Pat. No. 5,724,357 to Derks discloses a wireless remote response system comprising a base unit which retrieves user-entered responses from a plurality of remote response units, each of which is provided to a user. The base unit transmits a base data package over a wireless communication link to the plurality of remote response units, which decode the base data packet and load into memory a portion of the decoded base data package at each response unit. Each response unit examines the characters loaded into the memory and determines and processes the characters that pertain to that particular response unit.

U.S. Pat. No. 6,302,698 to Ziv-El discloses a networked teaching and learning system comprising a plurality of student computers, a network server and at least one teacher's computer. The at least one teacher's computer includes comparison and evaluation logic in communication with the student computers for comparing and evaluating each student keystroke with the characters of an answer, if any, immediately after every student keystroke. The teaching and learning system provides character-by-character evaluation for quick learning feedback for students, as well as simultaneous observation at the teacher's computer of multiple student responses identified as correct or incorrect. The teaching and learning system enables quick construction of various exercise types, the scoring of unanticipated responses, and the introduction of an explanation component in addition to a direct response to a question.

U.S. Pat. No. 6,790,045 to Drimmer discloses a method and system for analyzing student performance by classifying student performance into discrete performance classifications associated with corresponding activities related to an electronic course. An observed student performance level for at least one of the performance classifications is measured. A benchmark performance level or range is established for one or more of the performance classifications. It is then determined whether the observed student performance level is compliant with the established benchmark performance level for the at least one performance classification. Instructive feedback is determined for the observed student based upon any material deviation of the observed student performance from at least one benchmark.

U.S. Patent Application Publication No. 2004/0033478 to Knowles et al. discloses a participant response system comprising a plurality of wireless handsets assigned to participants of an event. Each handset has a keyboard for allowing a participant to input a response and has audio capability to allow the participant to receive and input audio. Each handset is configurable either as a participant response handset to allow a participant to enter a response, or as a base station.

U.S. Patent Application Publication No. 2004/0072136 to Roschelle et al. discloses a method and system for assessing a student's understanding of a process that may unfold over time and space. The system comprises thin client devices in the form of wireless, hand-held, palm-sized computers that communicate with a host workstation. The system provides a sophisticated approach of directing students to perform self-explanation, and enables instructors to enhance the value of this pedagogical process by providing meaningful and rapid feedback in a classroom setting.

U.S. Patent Application Publication No. 2004/0072497 to Buehler et al. discloses a response system and method of retrieving user responses from a plurality of users. The response system comprises a plurality of base units and a plurality of response units. Each of the response units is adapted to receive a user input selection and to communicate that user's input selection with at least one base unit utilizing wireless communication. Personality data is provided for the response units to facilitate communication with a particular base unit. The personality data of a particular response unit is changed when it is desired to change the base unit to which that response unit communicates. This allows a response unit to become grouped with a particular base unit at a particular time and to become grouped with another base unit at another particular time.

U.S. Patent Application Publication No. 2004/0126745 to Bell et al. discloses a method and apparatus for improving math skills. Groups of problems are presented to a student in a sequential manner and points are awarded to the student when the student enters a correct response. Statistics representing the student's performance are recorded and may be viewed in a variety of selectable formats so that parents, teachers and other interested parties can track the student's progress.

U.S. Patent Application Publication No. 2004/01800317 to Bodner et al. discloses a system and method for analyzing student performance and providing feedback regarding the student performance to an instructor, parent or directly to the student. The system communicates in real time with an educational program to provide contemporaneous feedback or recommendations regarding student performance. In addition the system evaluates the effectiveness of the educational program itself and tracks progress at different levels for example, a student, class, school, or district level. Comprehensive data analysis and statistical computation are performed.

Although the above participant response systems allow responses to questions received from the remote units to be tabulated by the host computer, the manner by which test results are displayed by the host computer presents challenges. In prior art participant response systems, the answers to questions are typically displayed on separate pages independent of the questions. This of course makes it difficult for teachers to discuss answers with students. Also, for privacy reasons it is desired that aggregate data concerning test results be initially displayed while still providing ready access to more detail. In prior art participant response systems, it is often required to export test results to third party programs for processing in order to generate the desired level of result analysis.

It is therefore an object of the present invention to provide a novel participant response system employing a graphical response analysis tool.

### SUMMARY OF THE INVENTION

Accordingly, in one aspect there is provided a participant response system comprising processing structure running an assessment during which participants are prompted to respond to one or more information requests; a plurality of remote units communicating with said processing structure, said remote units being used by participants to input responses to information requests and conveying received response data to said processing structure, said processing structure executing a graphical response data analysis tool that processes received response data thereby to generate response performance data in differing levels; and at least one display device communicating with said processing structure and operable to display graphically said response performance data in one or more of said differing levels.

In one embodiment, the at least one display device is initially conditioned by the processing structure to present response performance data graphically in a low level form. The at least one display device initially presents the response performance data as at least one selectable graphical object. In response to selection of the selectable graphical object, the at least one display device is conditioned by the processing structure to present the response performance data graphically in a high level form. The high level form may be presented in one of a histogram, bar chart, graph and pie chart.

In one embodiment, the graphical response data analysis tool comprises a user interface that is displayed on the at least one display device. The user interface comprises a category selection panel in which a list of selectable categories is presented and a main viewing area. The main viewing area presents response performance data associated with the category selected from the list. One or more of the categories in the list may comprise selectable subcategories. The processing structure may be responsive to user selected criteria to limit presented response performance data to that meeting the criteria.

According to another aspect there is provided a participant response system comprising processing structure running an assessment during which participants are prompted to respond to one or more information requests; and a plurality of remote units communicating with said processing structure, said remote units being used by participants to input responses to information requests and conveying received response data to said processing structure, said processing structure executing a graphical response data analysis tool that processes the received response data thereby to generate response performance data, wherein at least one of said remote units processes received response data prior to conveying the response data to said processing structure thereby to distribute the response data processing load.

In one embodiment, a plurality of remote units processes received response data prior to conveying the response data to the processing structure. In one form, the information requests are questions. In this case, the processing structure transmits answer data to remote units that process response data. The remote units use the answer data to grade input responses and convey the results to the processing structure.

According to yet another aspect there is provided a participant response system comprising processing structure running an assessment during which participants are prompted to respond to one or more information requests; a plurality of remote units communicating with said processing structure, said remote units being used by participants to input responses to information requests and conveying received response data to said processing structure, said processing structure executing a graphical tool that maintains a list of the remote units communicating with said processing structure, said list identifying each remote unit by type; and at least one display device communicating with said processing structure and operable to display graphically said list.

In one embodiment, the graphical tool monitors the state of the participant response system and updates the list so that remote unit status is identified. The processing structure also generates response performance data based on the received response data and correlates the response performance data with remote unit type.

### BRIEF DESCRIPTION OF THE DRAWINGS

Embodiments will now be described more fully with reference to the accompanying drawings in which:

FIG. 1 is a top plan view of a classroom employing a participant response system;

FIG. 2 is a schematic view of the participant response system of FIG. 1;

FIG. 3 is a schematic view of an interactive whiteboard forming part of the participant response system of FIGS. 1 and 2;

FIGS. 4a and 4b are side elevational and top plan views of a receiver forming part of the participant response system of FIGS. 1 and 2;

FIG. 5 is a schematic block diagram of the receiver of FIGS. 4a and 4b;

FIG. 6 is a front plan view of a remote unit forming part of the participant response system of FIGS. 1 and 2;

FIG. 7 is an enlarged front plan view of the remote unit display;

FIG. 8 is a schematic block diagram of the remote unit of FIG. 6;

FIGS. 9 and 10 show a student roster;

FIG. 11 shows a test question displayed on the touch surface of the interactive whiteboard of FIG. 3; and

FIG. 12 shows a graphical user interface (GUI) window of a graphical response data analysis tool displaying test results;

FIG. 13 shows an expanded GUI window displaying the test results of FIG. 12 in pie chart form;

FIG. 14 shows the expanded GUI window of FIG. 13 during a right click mouse event;

FIGS. 15 and 16 show another expanded window displaying the test results of FIG. 12 in bar graph form; and

FIGS. 17 to 33 show information presented on an alternative GUI of the graphical response data analysis tool.

### DETAILED DESCRIPTION OF THE EMBODIMENTS

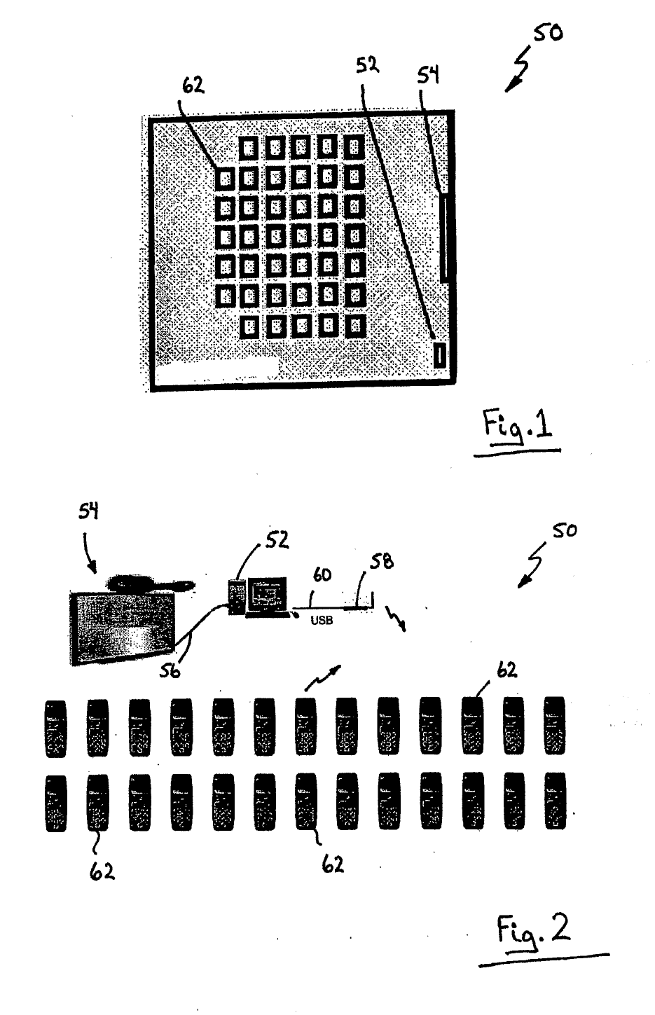

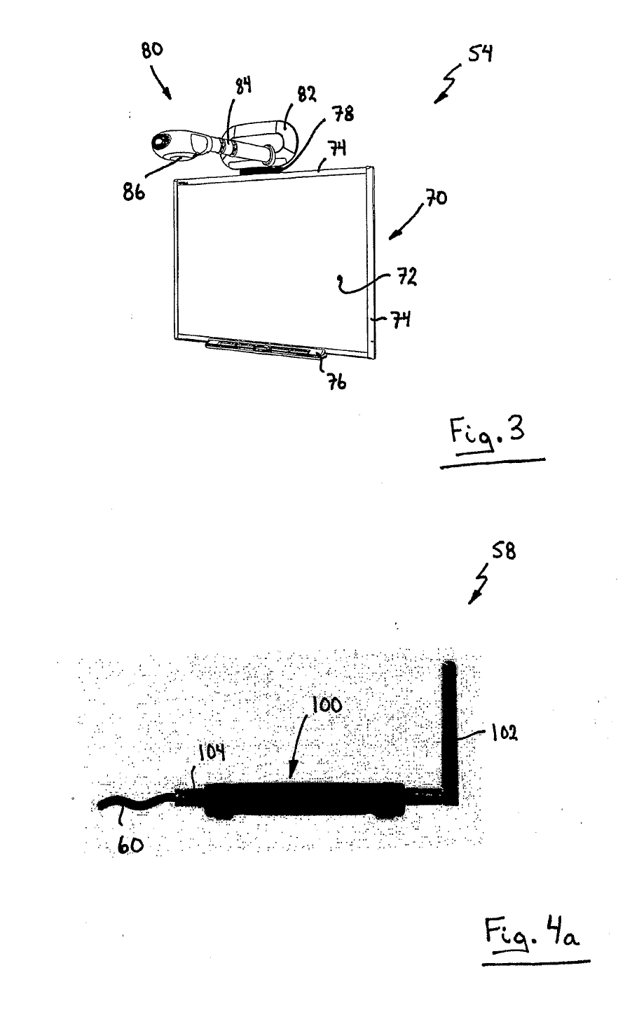

Turning now to FIGS. 1 and 2, a participant response system is shown and is generally identified by reference numeral 50. In this embodiment, participant response system 50 is employed in a classroom, lecture hall or theatre of an educational institution such as for example a school, university, college or the like and is used to create tests, quizzes or assessments (“tests”), administer created tests to a class of students and analyze the results of administered tests. As can be seen, the participant response system 50 comprises a base or host computer 52, an interactive whiteboard (IWB) 54 physically connected to the host computer 52 via a cable 56, a radio frequency (RF) receiver 58 physically connected to the host computer 52 via a universal serial bus (USB) cable 60, and a plurality of wireless, hand-held remote units 62 communicating with the host computer 52 via the receiver 58.

The participant response system firmware in this embodiment is implemented on top of IEEE802.15.4 media access control (MAC) protocol layer software provided by Texas Instruments (TI). The TI MAC protocol layer software comprises a small real-time kernel and a call Z-stack operating system (OS) to provide simple real-time OS facilities such as for example, timer management, task management and interrupt management. Abstraction layers are used to separate the OS and the hardware drivers for ease of porting to a different OS and hardware platform.

In this embodiment, the IWB 54 is a 600i series interactive whiteboard manufactured by SMART Technologies ULC, of Calgary, Alberta, Canada, assignee of the subject application. As is best seen in FIG. 3, the IWB 54 comprises a large, analog resistive touch screen 70 having a touch surface 72. The touch surface 72 is surrounded by a bezel 74. A tool tray 76 is affixed to the bezel 74 adjacent the bottom edge of the touch surface 72 and accommodates one or more tools that are used to interact with the touch surface. The touch screen 70 is mounted on a wall surface via a mounting bracket 78. A boom assembly 80 is also mounted on the wall surface above the touch screen 70 via the mounting bracket 78. The boom assembly 80 comprises a speaker housing 82 accommodating a pair of speakers (not shown), a generally horizontal boom 84 extending outwardly from the speaker housing 82 and a projector 86 adjacent the distal end of the boom 84. The projector 86 is aimed back towards the touch screen 70 so that the image projected by the projector 86 is presented on the touch surface 72.

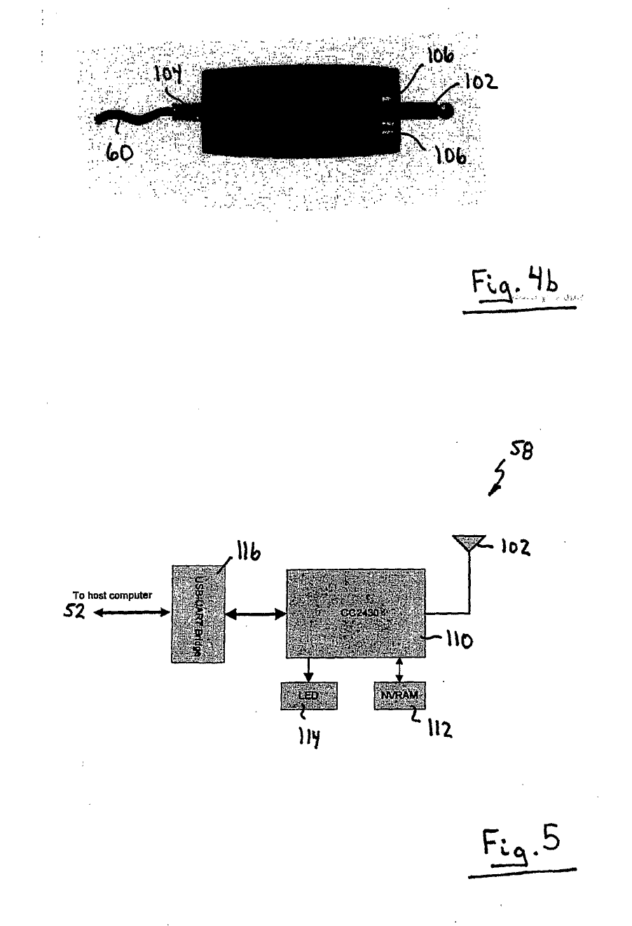

Turning now to FIGS. 4a, 4b and 5, the receiver 58 is better illustrated. As can be seen, the receiver 58 comprises a casing 100 adapted to be desktop or wall mounted. An L-shaped omni-directional antenna 102 is mounted on the front end of the casing 100. The rear end of the casing 100 receives the USB cable 60. A plurality of light emitting diodes (LEDs) 106 is provided on the top surface of the casing 100. During operation of the receiver 58, the LEDs 106 are illuminated to provide visual feedback concerning the operational status of the receiver 58. In this embodiment, the LEDs 106 comprise a power status LED and communications status LEDs. Alternatively, the receiver 58 may provide visual feedback via a display such as a liquid crystal display (LCD) or via both LEDs and an LCD. The receiver electronics are accommodated by the casing 100 and comprise a microprocessor 110 that communicates with non-volatile, random access memory (NVRAM) 112, an LED driver 114 and a USB-UART bridge 116. Power is provided to the receiver 58 via the USB cable connection 60.

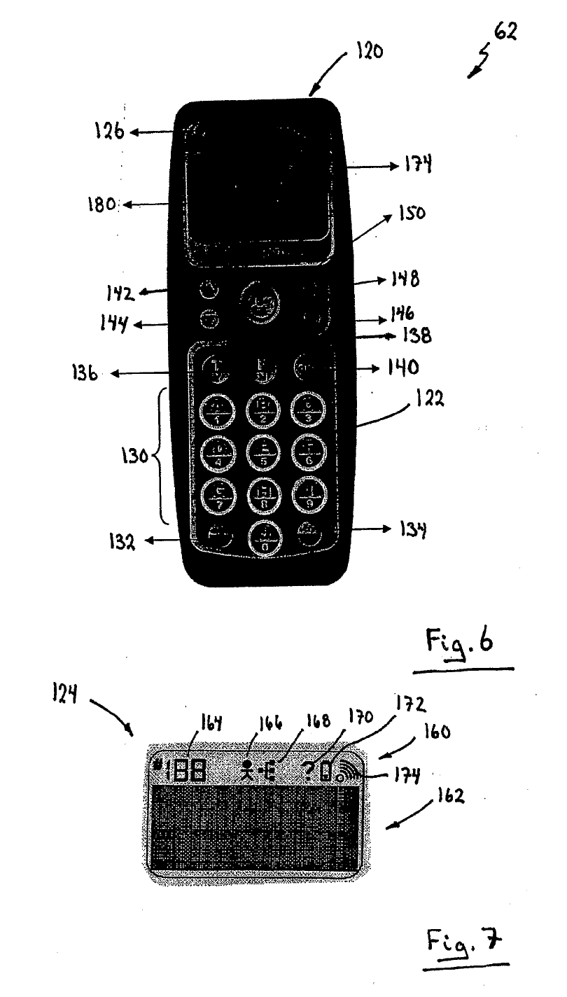

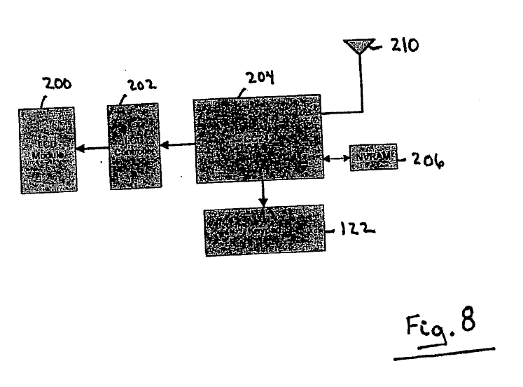

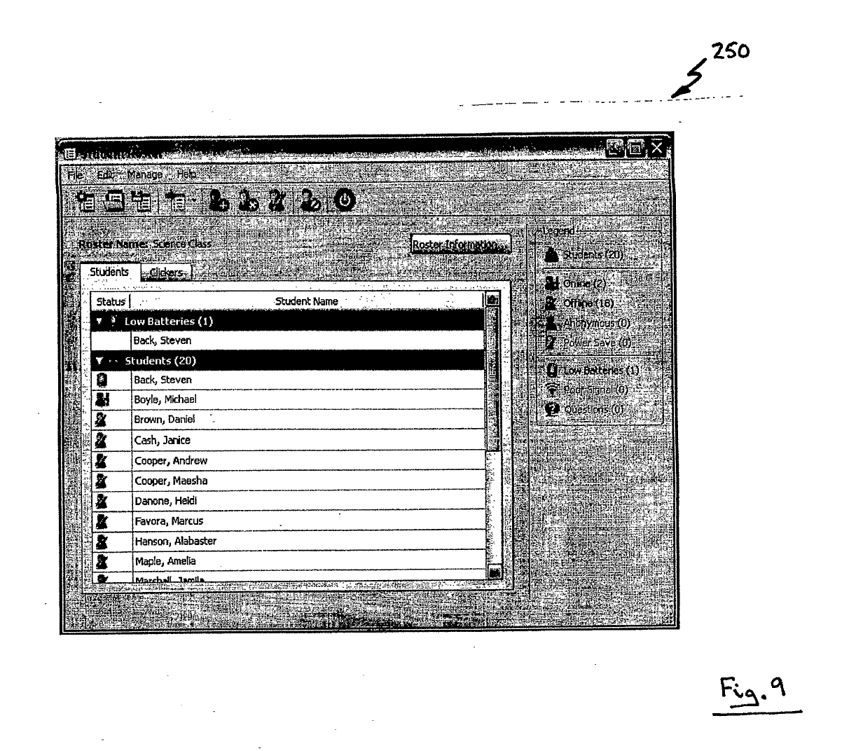

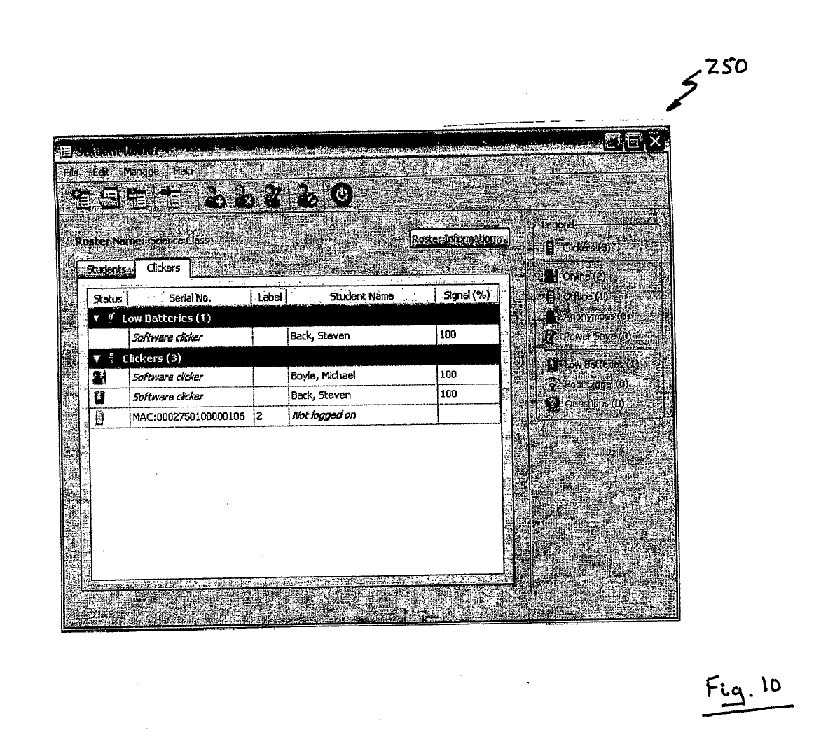

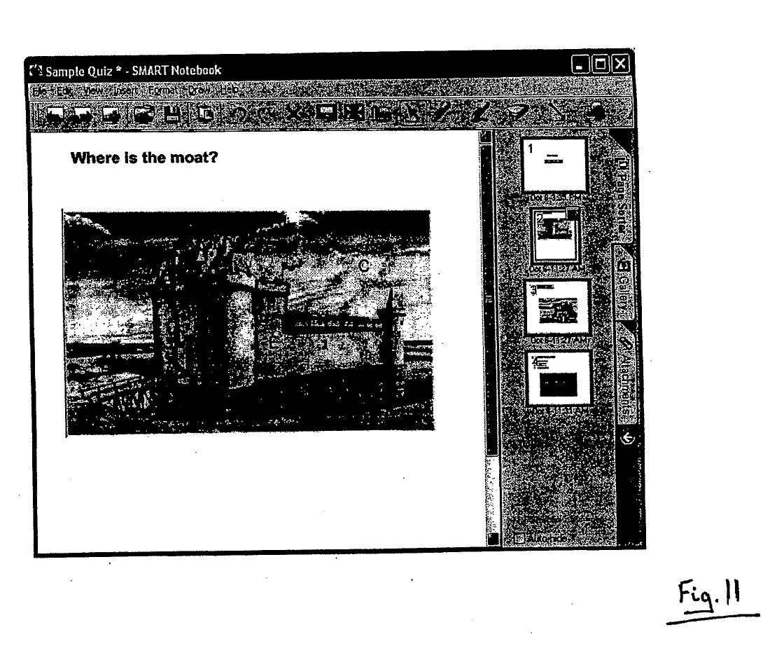

One of the remote units 62 is best shown in FIGS. 6 to 8. As can be seen, the remote unit 62 comprises a casing 120 having a keypad 122, a display 124, a power button 126 and an optional battery status LED (not shown) on its front surface. In this embodiment, keypad 122 comprises ten (10) dual character (A to J/0 to 9) buttons 130, a plus/minus (+/−) button 132, a fraction/decimal ((x/y)/*) button 134, a true/yes (T/Y) button 136, a false/no (F/N) button 138, a delete (del) button 140, up and down scroll (̂/v) buttons 142 and 144, a menu button 146, a question/hands up (?) button 148 and an enter button 150. Those of still in the art will appreciate that the form of the keypad 122 shown in FIGS. 6 to 8 is exemplary. The keypad 122 may of course comprise an alternative set of keys, a full QWERTY or DVORAK key set or a subset thereof. If desired, the entire physical keypad or a portion thereof may be replaced with a touch screen overlying the LCD display 124 to allow a user to interact with virtual keys.

The display 124 comprises an upper row of LCD icons 160 disposed above a character display area 162. The LCD icons 160 comprise a question number icon 164, a user status icon 166, a network status icon 168, a hands-up (?) icon 170, a battery status icon 172 and a transmission status icon 174. The character display area 162 comprises a 128×48 pixel array that is divided into three lines 180. Each line 180 can display a total of sixteen (16) characters. Remote unit electronics are accommodated by the casing 120 and comprise an LCD controller 200 that communicates with the display 124, an LCD driver 202 that drives the LCD controller 200, a microprocessor 204 that communicates with the LCD driver 202 and the keypad 122, as well as with NVRAM 206 and a printed circuit board, omni-directional antenna 210. Power is provided to the remote unit 62 by non-rechargeable and rechargeable batteries (not shown) accommodated by the casing. Alternate power sources such as solar cells or manually cranked generators can also be used to power the remote units.

Although a particular form of remote unit 62 is illustrated and described those of skill in the art will appreciate that the remote units may take a variety of forms. For example, the remote units 62 may be cellular phones, personal digital assistants (PDAs), ultra-mobile personal computers, laptop computers, portable media devices with wireless capabilities or other suitable devices that allows users to input responses to questions. Of course, combinations of the above devices are permissible so that each user is not required to use the same input device.

The host computer 52 runs participant response application software comprising a session manager that maintains the state of the participant response system 50. In particular, the session manager maintains a student roster 250 as shown in FIGS. 9 and 10. The student roster 250 identifies the class name, the students in the class by first and last name, the log-in status of the students and whether any of the logged-in students are using a remote device 62 that has a low battery level. The manner by which remote unit battery levels are determined is described in co-pending U.S. patent application Ser. No. ______ to Doerksen et al. entitled “Participant Response System Employing Battery Powered, Wireless Remote Units” filed on even date herewith and assigned to the assignee of the subject application, the content of which is incorporated herein by reference.

The session manager is responsible for downloading the question answer formats e.g. true/false, yes/no, multiple choice, numerical etc. for the questions of the test being administered, to the remote units 62, for receiving answers to questions input by students using the remote units 62 and for keeping track of the question each student is answering. The session manager is also responsible for aggregating answers to questions received from students into results, and grading the answers to questions.

The host computer 52 also runs SMART Notebook™ whiteboarding software to facilitate interaction with the IWB 54. As a result, the display output of the host computer 52 is conveyed to the IWB 54 and is used by the projector 86 to present an image on the touch surface 72. Pointer interactions with the touch surface 72 are detected by the touch screen 70 and conveyed to the host computer 52. The display output of the host computer 52 is in turn adjusted by the host computer to reflect the pointer activity. The host computer 52 and IWB 54 thus form a closed-loop. Depending on the nature of the pointer activity, the host computer 52 may treat the pointer contacts as writing or erasing or may treat the pointer contacts as mouse events and use the mouse events to control execution of application programs, such as for example the participant response notebook application, executed by the host computer 52. In this manner, the IWB 54 can be used by the instructor to create and administer tests and to analyze test results.

In addition, the participant response application software comprises an administration application that provides a graphical user interface for the session manager to allow the instructor to define and refine test questions, create tests using defined questions, start and stop tests and visualize test results. The administration application also allows question definitions to be imported, allows responses, grades and results to be exported and allows tests to be printed together with answer keys. The administration application has two modes of operation, namely a Notebook integrated mode and a stand-alone mode. In the Notebook integrated mode, the administration application is integrated into the SMART Notebook™ software. The stand-alone mode is used when the participant response system 50 includes a different brand of IWB 54 or does not include an IWB.

In this embodiment as shown in FIG. 2, the host computer 52, IWB 54 and receiver 58 are physically connected by cables 56 and 60. Messages exchanged between the host computer 52, IWB 54 and receiver 58 are structured using extensible markup language (XML) over HTTP. The receiver 58 and the remote units 62 communicate over a wireless radio frequency (RF) communications network. The microprocessor 110 of the receiver 58 thus provides both a USB interface and an RF interface and runs a service that translates messages in USB protocol to messages in radio frequency (RF) wireless protocol and vice versa as well as IEEE802.15.4 MAC layer software to manage the IEEE802.15.4 network thereby to permit the host computer 52 and remote units 62 to communicate. Messages exchanged between the session manager and the receiver 58 comprise a header, a command identification, message bytes and a checksum. Consistent overhead byte stuffing is employed to provide frame delimiting of packets thereby to facilitate the determination of the start and end of command packets. Messages exchanged between the receiver 58 and the remote units 62 do not include the header and the checksum as the IEEE802.15.4 protocol is used to handle packet addressing and ensure packet integrity.

The messages exchanged between the session manager, the receiver 58 and the remote units 62 include diagnostic messages, status messages and command messages. For example, in this embodiment diagnostic messages comprise, but are not limited to, firmware information query messages, remote unit transmit power query messages and channel identification query messages. Status messages comprise, but are not limited to, remote unit status messages, network status messages and personal area network (PAN) ID messages. Command messages comprise, but are not limited to, log-in messages, log-out messages, log-in grant messages, question download messages, optional answer download messages, answer upload messages, hands-up messages, test start messages and test end messages.

In this embodiment, wireless communications between the host computer 52 and the remote units 62 are carried out according to the IEEE802.15.4 specification, as described in co-pending U.S. patent application Ser. No. ______ to Lam entitled “Participant Response System With Reduced Communications Bandwidth” filed on even date herewith and assigned to the assignee of the subject application, the content of which is incorporated herein by reference.

When a test is being administered to students, the session manager generates one or more question download messages that include the question answer formats for the questions of the test. The question download messages are then sent to the receiver 58, which in turn embeds the question download messages in the next beacon frame and broadcasts the beacon frame embodying the question download messages to all of the remote units 62 simultaneously. Upon receipt of the beacon frame, each active remote unit 62 in turn loads the question download messages into memory 206. The student associated with each remote unit 62 can then use the scroll buttons 142 and 144 to select the question to which the student wishes to respond so that the question answer format for the selected question is displayed. The host computer 52 also provides display data to the IWB 54 resulting in the projector 78 projecting the questions of the test on the touch surface 72 of the touch screen 70. In this embodiment, each question is displayed on the touch surface 70 independently as shown in FIG. 11 thereby to facilitate viewing by the students.

When the question is a true/false type question, the question answer format corresponding to the question that is displayed by the remote units 62 provides true and false selections. In this case, the question can be answered using either the true/yes button 136 or the false/no button 138. Likewise, when the question is a yes/no type question, the question answer format corresponding to the question that is displayed by the remote units 62 provides yes and no selections. In this case, the question can be answered using either the true/yes button 136 or the false/no button 138. When the question is a multiple choice or numeric type question, the question answer format corresponding to the question that is displayed by the remote units 62 provides choice selections or a line for the numeric answer. In this case, the question can be answered using the dual character buttons 130, the +/−button 132 and/or fraction/decimal button 134.

When an answer has been input into a remote unit 62 via the keypad 122 and the enter button 150 has been pressed, the remote unit 62 generates an answer upload message that includes the question number and the student's answer and sends the answer upload message to the receiver 58, which in turn passes the answer upload message to the host computer 52. The session manager saves the answer upload message and analyzes the answer thereby to provide the results to the administration application. In particular, the session manager aggregates the responses received from the students for each question and compiles the results. As can be appreciated, the results can be made available in a variety of formats depending on the needs of the administration application. For example, the results may comprise a complete list of all responses for each question, identical answers provided by different students can be grouped so that answer percentages can be readily determined or the results may simply comprise the overall scores.

The administration application in this embodiment provides a graphical response analysis tool that enables the instructor to see various levels of detail concerning responses to questions without exporting the results to other programs together with the corresponding questions.

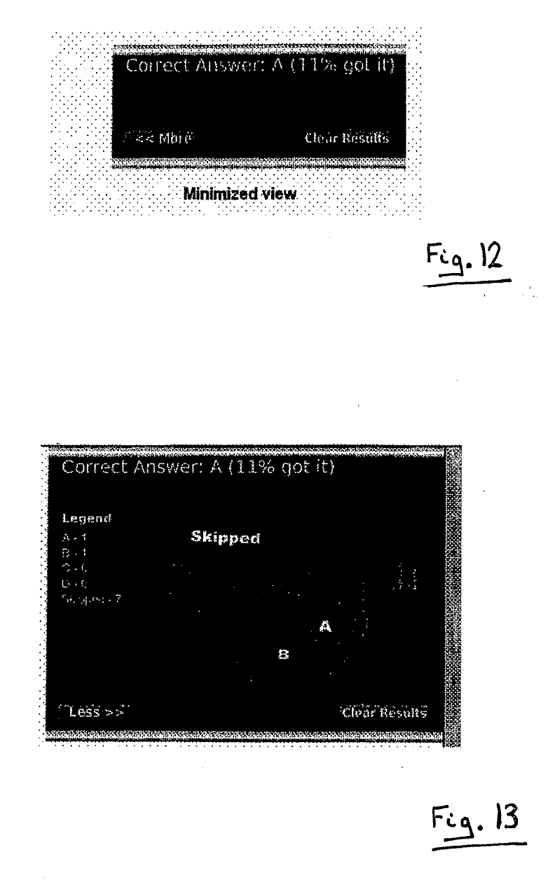

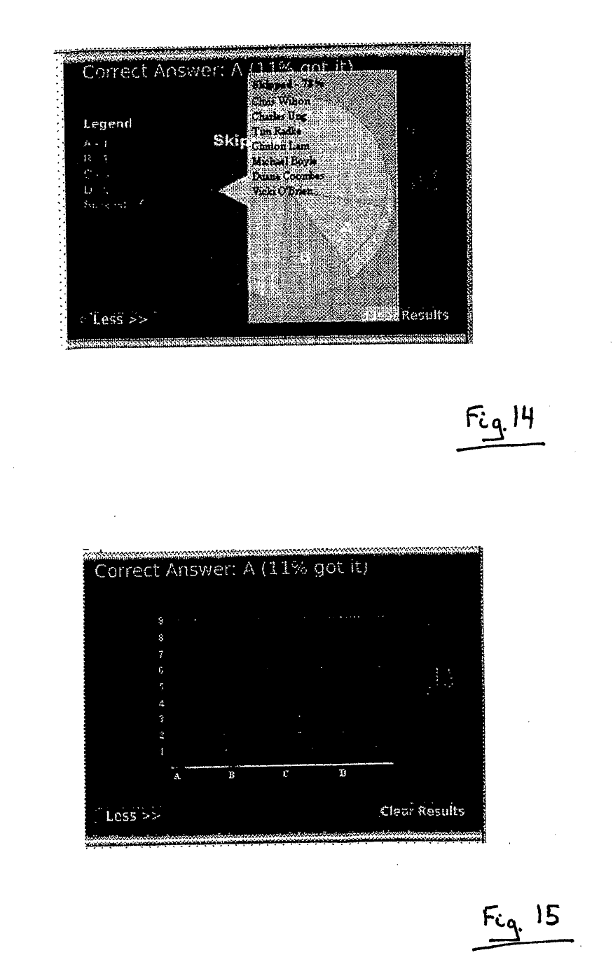

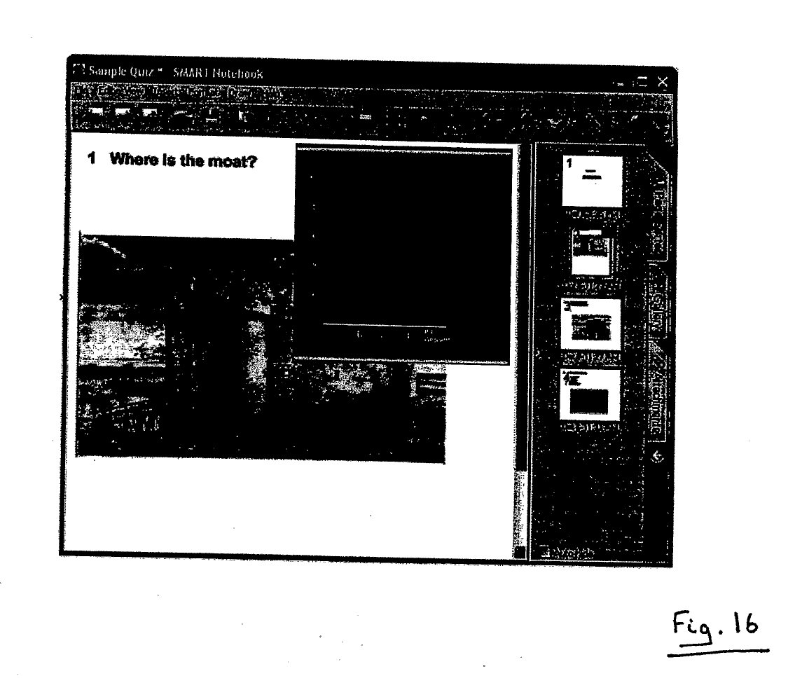

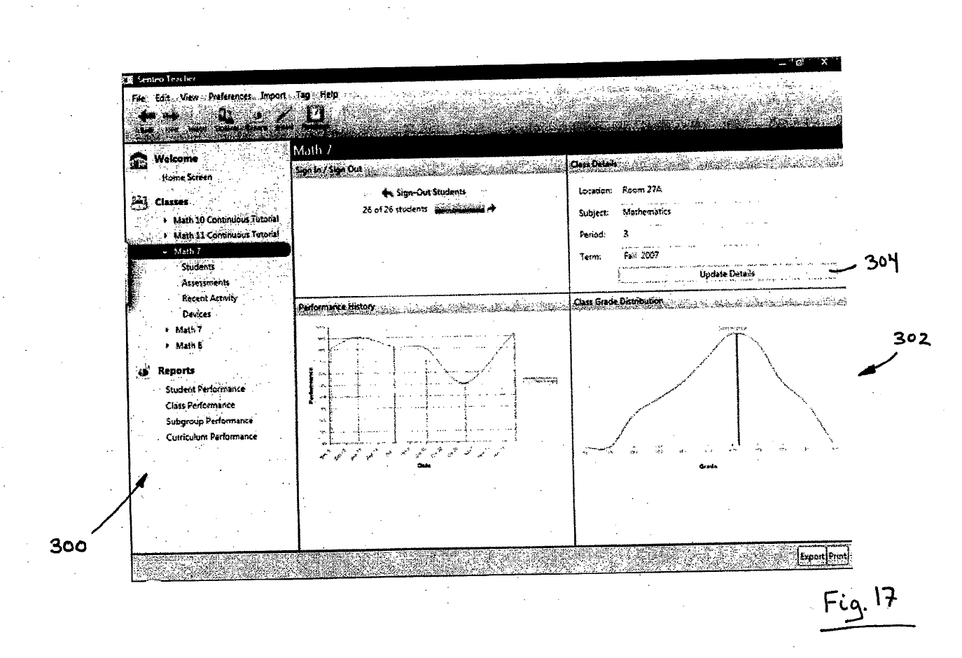

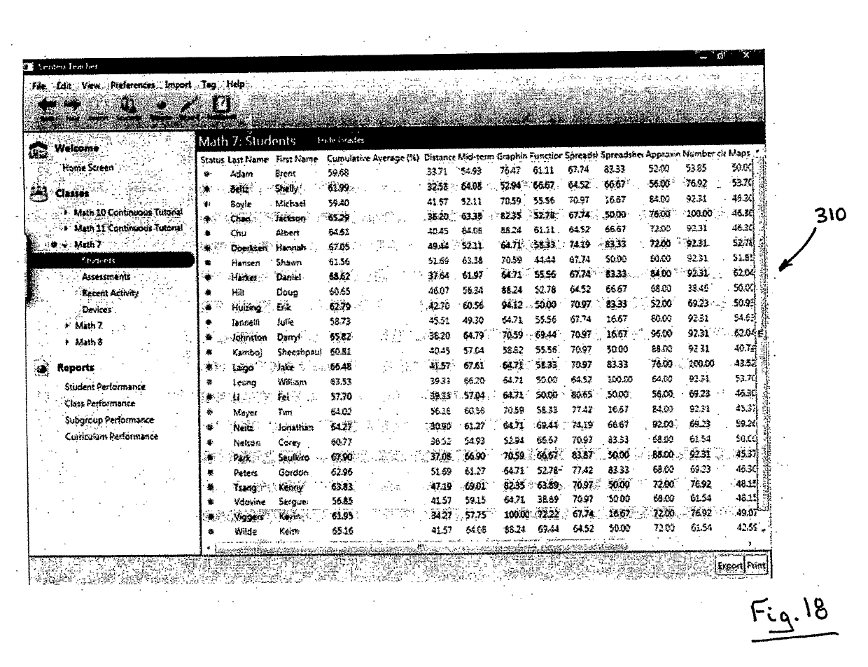

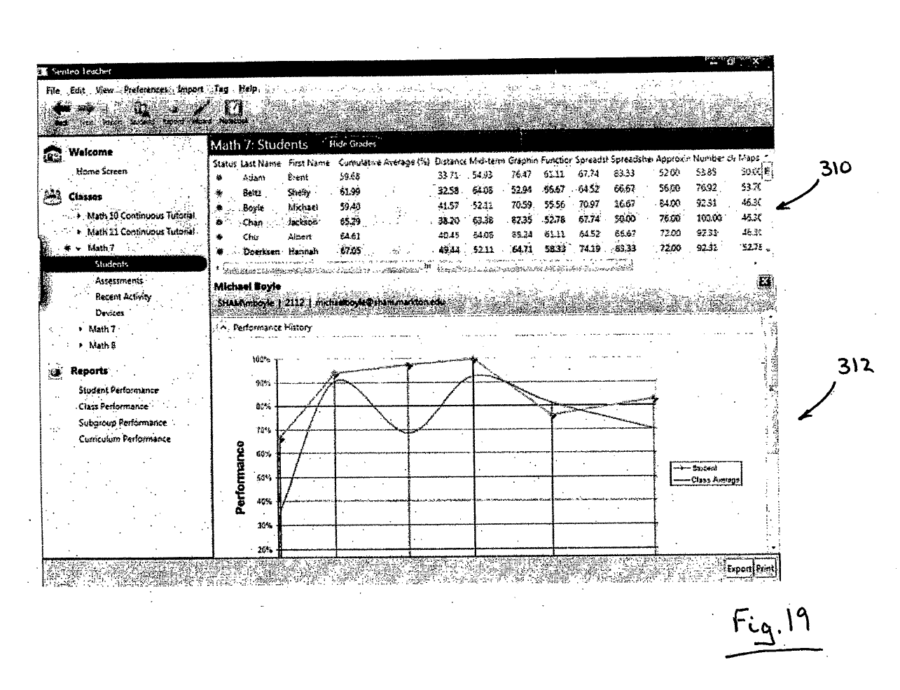

In one embodiment, when the answers to a question are to be examined visually and the graphical response data analysis tool is selected, a small graphical user interface (GUI) window is displayed over top of the corresponding question page using graphical controls, such as for example, Adobe Flash, as shown in FIG. 12. The window identifies the correct answer, low level aggregate response performance data such as the percentage of students who correctly answered the question, an expand button and a clear button. If the expand button is selected, higher level response performance data such as a graphical representation of the results is displayed as shown in FIG. 13. In this case, the graphical representation is a pie chart that shows the percentage of students who submitted identical answers as well as the percentage of students that did not submit a response to the question. The graphical representation also includes a legend, a histogram button, a clear button and a reduce button. If a right click mouse event is made over a section of the pie chart, the names of the students associated with that pie chart section are displayed as shown in FIG. 14. When the right click mouse event is terminated, the students names disappear. If the histogram button is selected, a bar graph showing the same results is displayed as shown in FIGS. 15 and 16. The bar graph similarly includes a clear button, a reduce button and a pie chart button and offers the same right click mouse event capability described above.

In situations where questions are mathematical requiring students to enter numerical answers, the graphical tool lumps identical numeric results into a histogram. Incorrect numeric results that are not repeated by numerous students i.e. the incorrect numeric results are unique, are placed in an “other” category. Incorrect numeric results that are repeated, whether identical or similar, can be accumulated and used to populate a histogram bin associated with the incorrect answer. This allows the instructor to identify situations where a number of students make a common or similar mistake allowing the teacher to explain the misconception(s).

If desired, the graphical tool can be configured to display high level answer detail initially rather than low level aggregate answer detail as described above. In this case, the graphical controls allow the level of answer detail to be reduced.

Also, if desired, the processing capabilities of the remote units 62 can be utilized to grade input answers. In this situation, in addition to command download messages, answer download messages are conveyed to the remote units 62. When a user inputs an answer to a question, the remote unit 62 compares the input answer with the corresponding answer download message and generates an answer upload message comprising one of two values signifying either a correct or incorrect response. As a result, some of the computing load is transferred to the remote units 62 reducing the processing burden placed on the host computer 52. If the system is configured for a practice mode, the remote unit can use the answer download messages to display the results to the user without transmitting answer upload messages to the host computer.

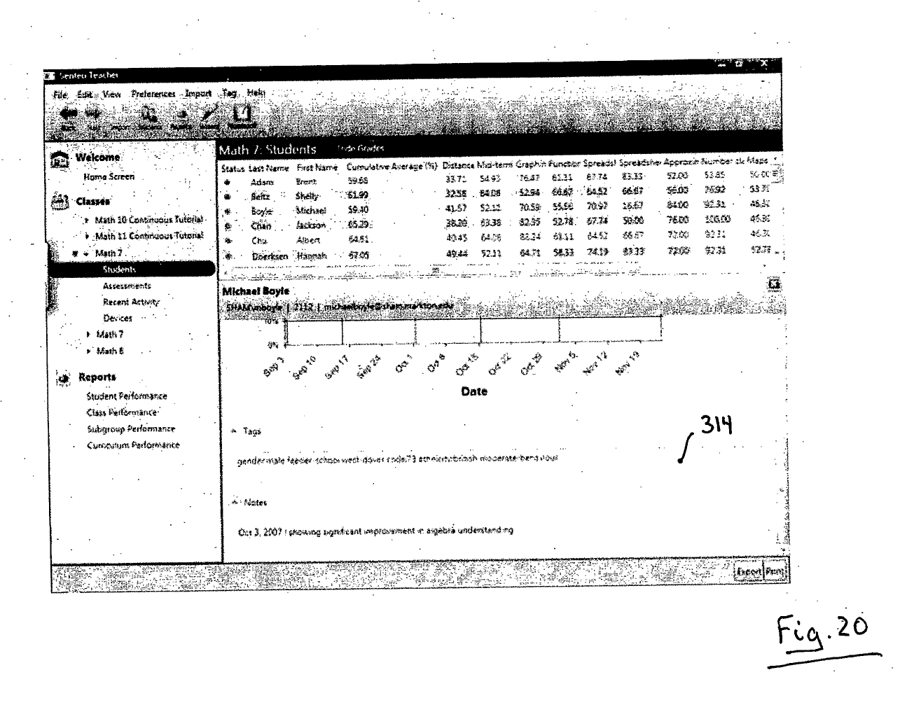

In an alternative embodiment, the graphical response data analysis tool provides the facility to visually display response performance data by class and to generate performance reports. In particular, the graphical response data analysis tool provides a graphical user interface comprising a selection pane 300 that displays available classes and available performance reports in a list as selectable items together with a main viewing area 302 that displays information relating to the class or performance report that has been selected. FIG. 17 shows a home screen displayed in the main viewing area for a selected class. As can be seen, the main viewing area in this case is divided into four primary quadrants. The top left quadrant identifies the ratio of students in the class which are currently logged-in with registered remote units 62. The top right quadrant shows class information and includes a selectable update button 304 to enable the class information to be updated. The bottom left quadrant shows a graph of the overall class performance as a percentage over time. The bottom right quadrant displays a graph showing the class grade distribution.

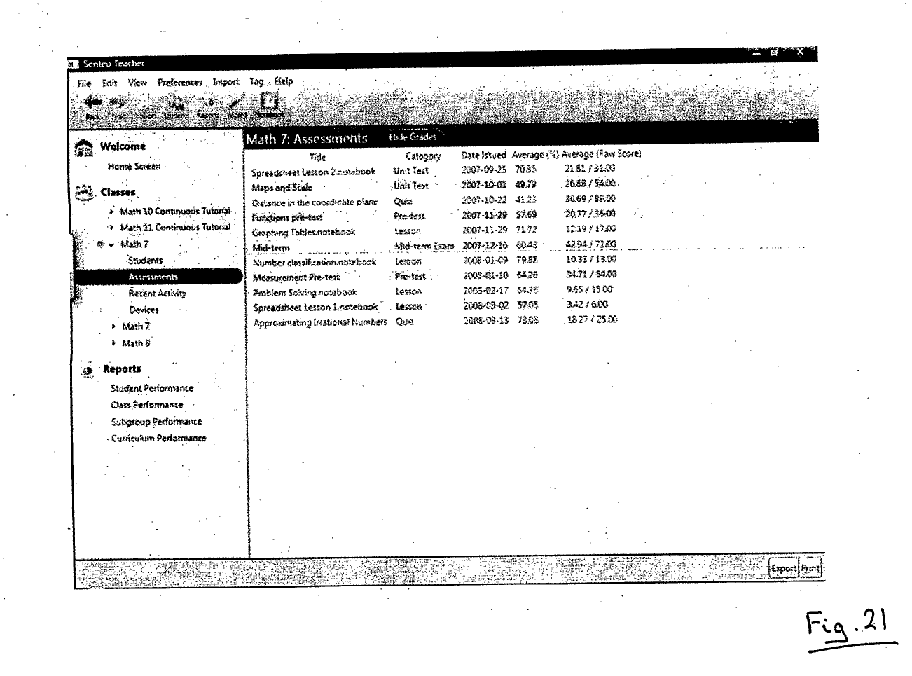

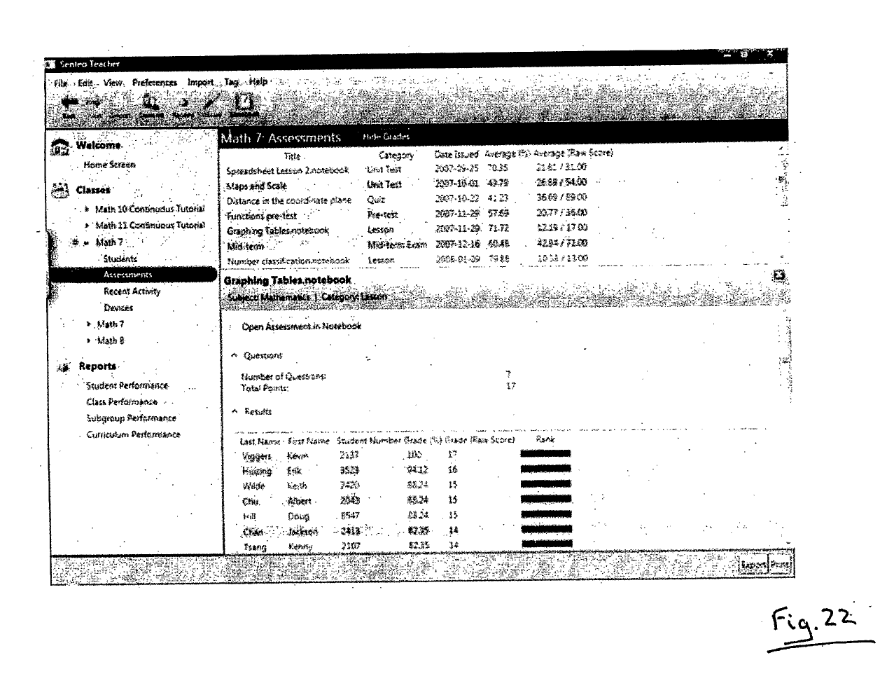

FIG. 18 shows a gradebook 310 displayed in the main viewing area 302 for students of a selected class. The gradebook identifies the individual students in the class and for each student, shows the student's cumulative average and the student's mark on each test or assessment. Selecting an individual student identified in the gradebook 310 results in a performance graph 312 for the student being displayed in the bottom half of the main viewing area 302 as shown in FIG. 19. The performance graph 312 plots both the student's performance and the class average.

If desired, user selected, personalized reporting criteria can be entered in a tag 314 so that the student performance information displayed in the main viewing area 302 is limited to information that meets the entered criteria as shown in FIG. 20.

FIG. 21 shows the information presented in the main viewing area 302 for assessments given to a selected class. As can be seen, the assessments are identified by title, category and data issued. The class average and the average raw score for each assessment are also provided. Selecting an individual assessment results in the display of further details concerning the class performance on the assessment as shown in FIG. 22.

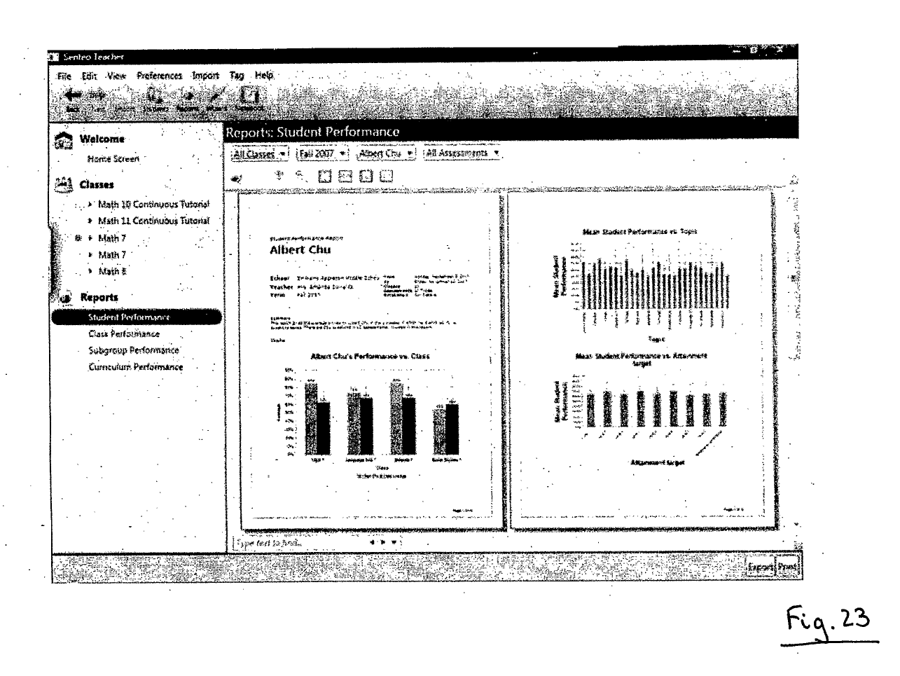

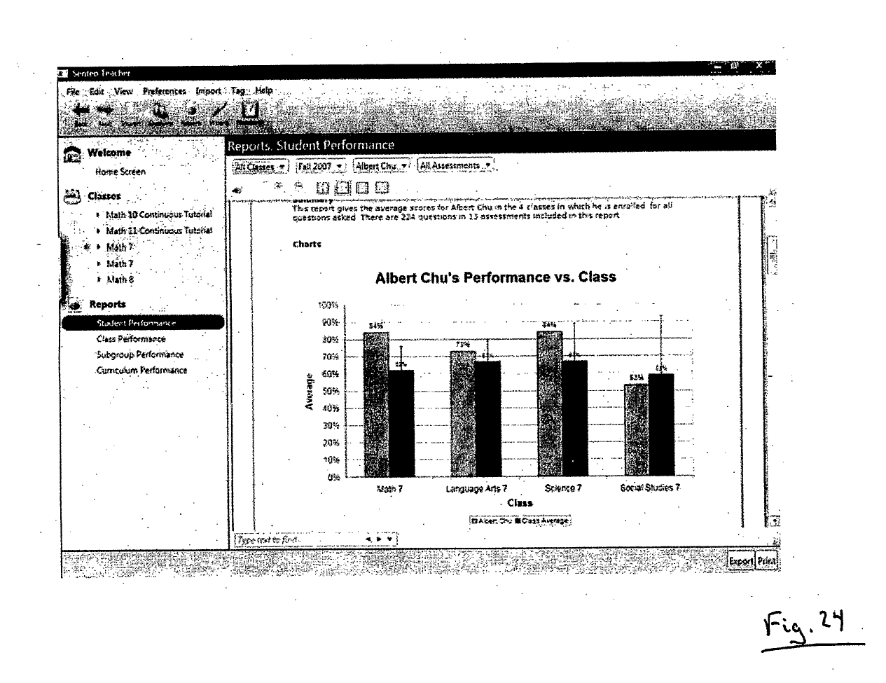

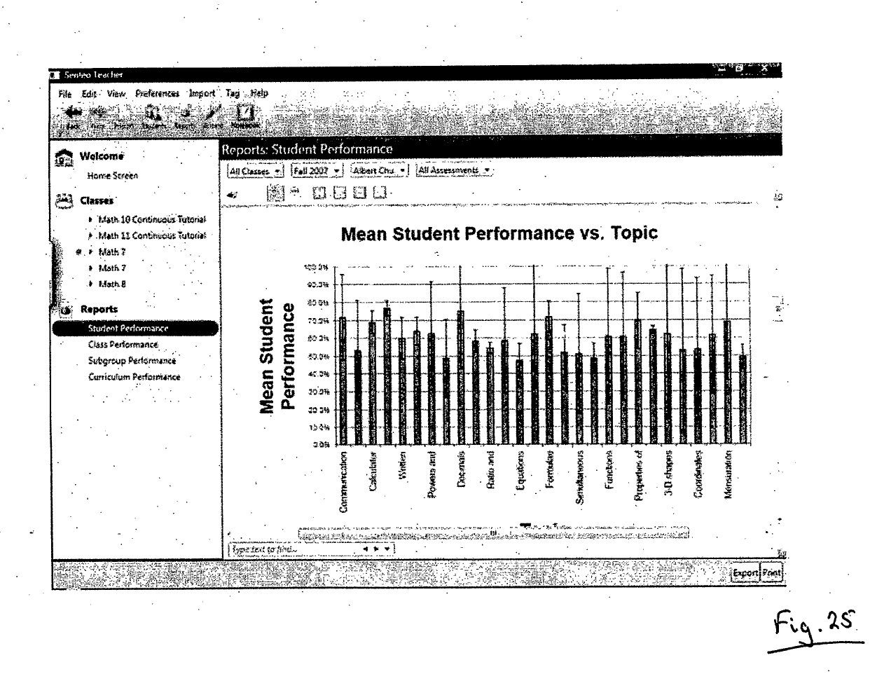

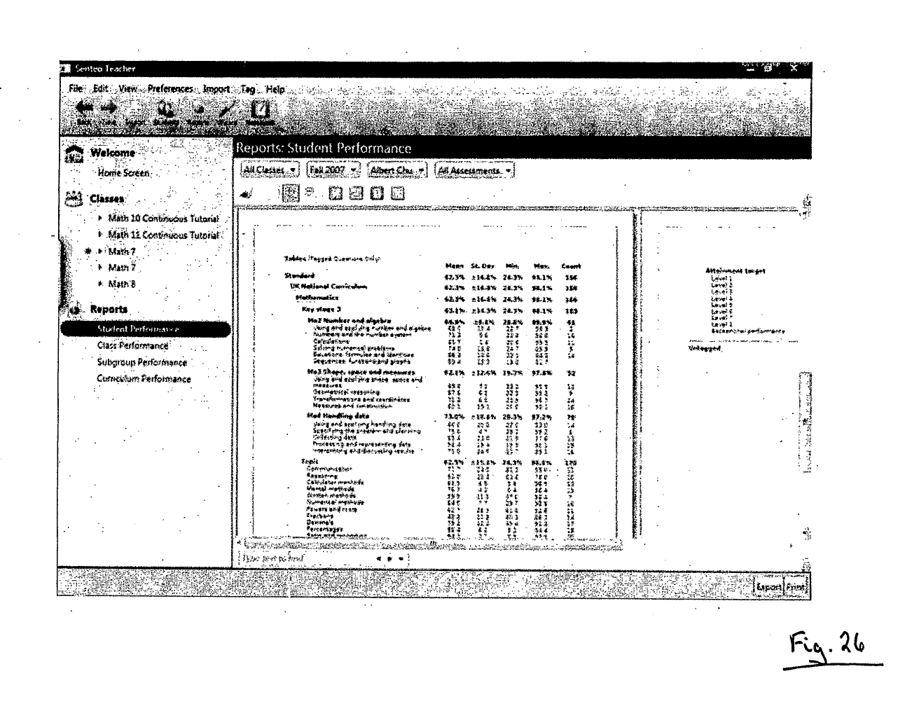

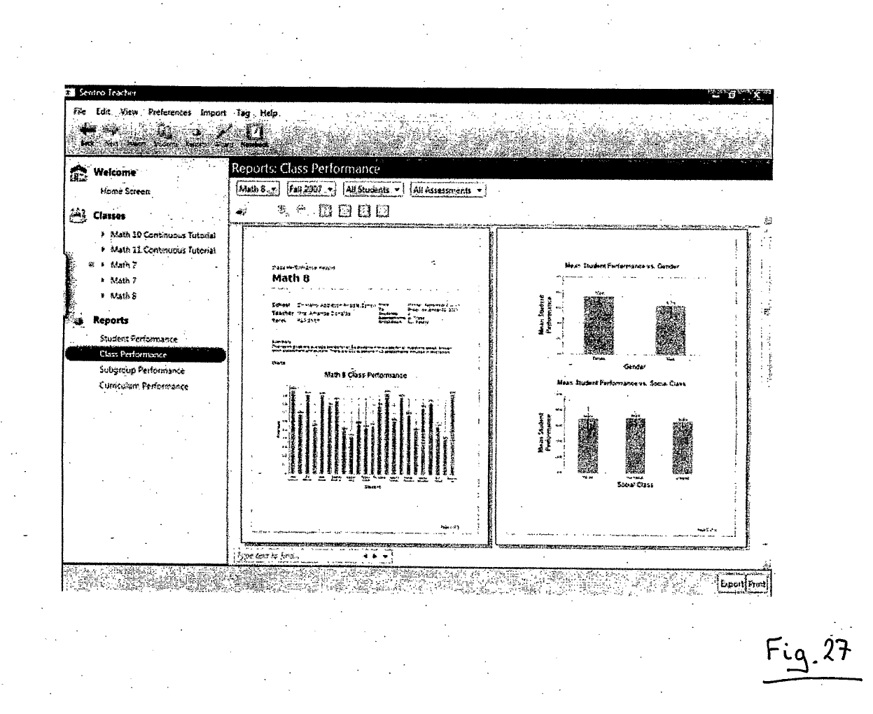

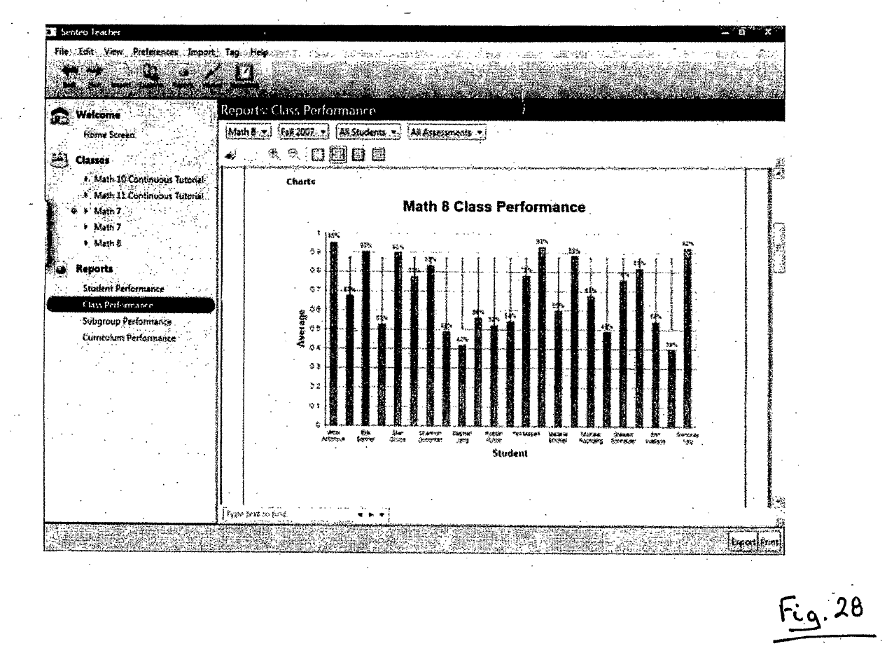

FIG. 23 shows a student performance report displayed in the main viewing area 302 for a selected student. As can be seen, in this case the main viewing area displays information concerning the student, school, teacher and year, together with graphical information concerning the student's performance. The graphical information includes the student's performance vs. class in bar chart form, the student's mean performance vs. topic in bar chart form and the student's mean performance vs. attainment target in bar chart form. Each of these bar charts can be selected and expanded to the entire main viewing area 302 as shown in FIGS. 24 and 25. Detailed student performance information can also be displayed in the main viewing area 302 as shown in FIG. 26.

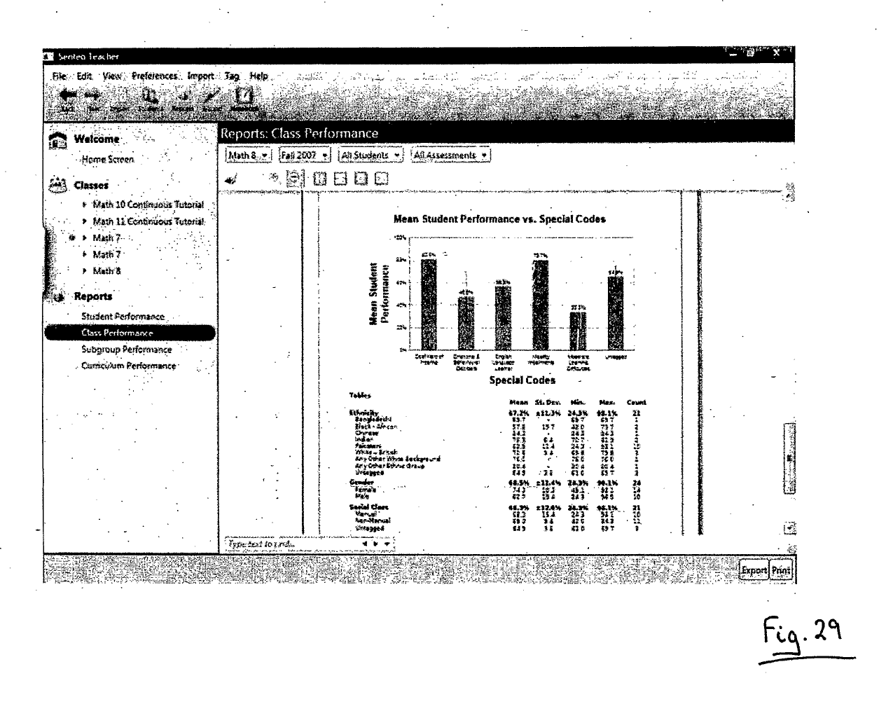

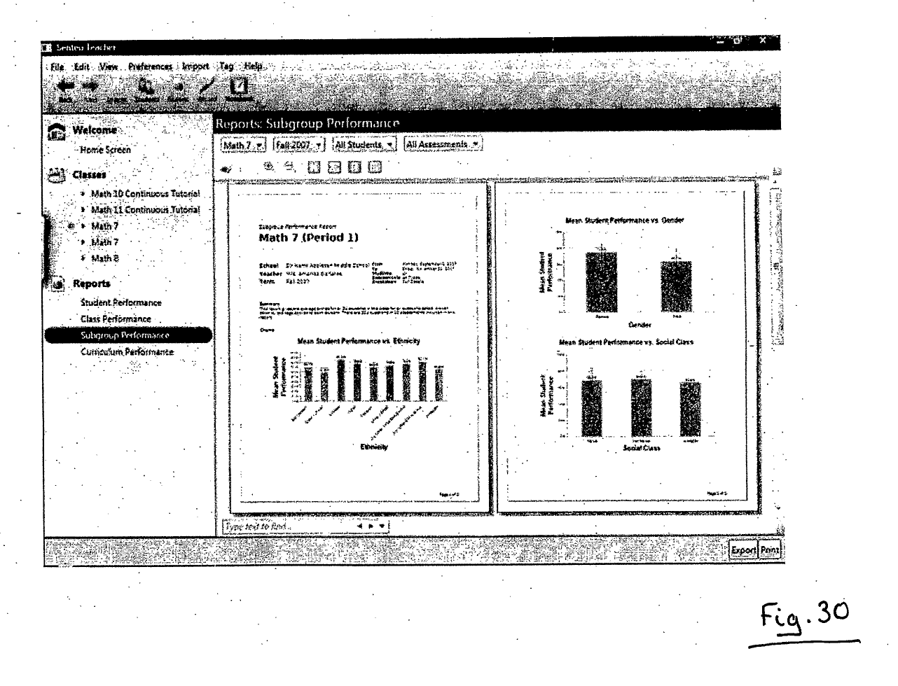

FIG. 27 shows class performance information displayed in the main viewing area 302 for a selected class. As can be seen, the displayed information includes a bar chart showing overall class performance, a bar chart showing mean student performance vs. gender and a bar chart showing mean student performance vs. social class. Each of these graphical charts can be selected and expanded to the entire main viewing area 302 as shown in FIG. 28. If desired, user selected reporting criteria can be input into tags and used to create customized reports as shown in FIG. 29.

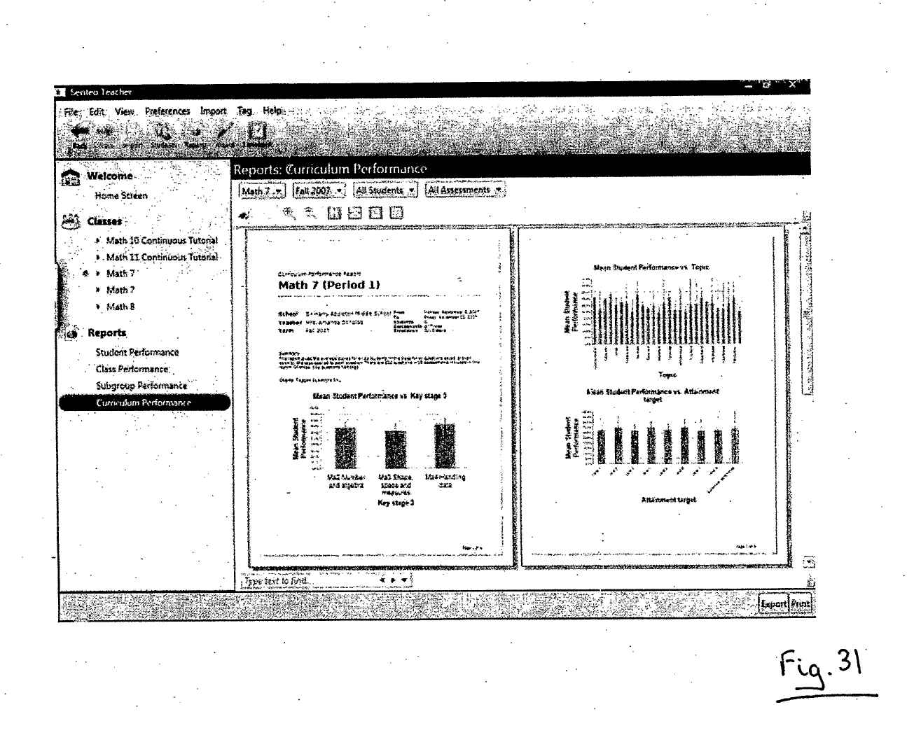

FIG. 30 shows performance information displayed in the main viewing area 302 for a subgroup of a selected class. The subgroup performance information is similar to that displayed for the class except limited to a subset of the class.

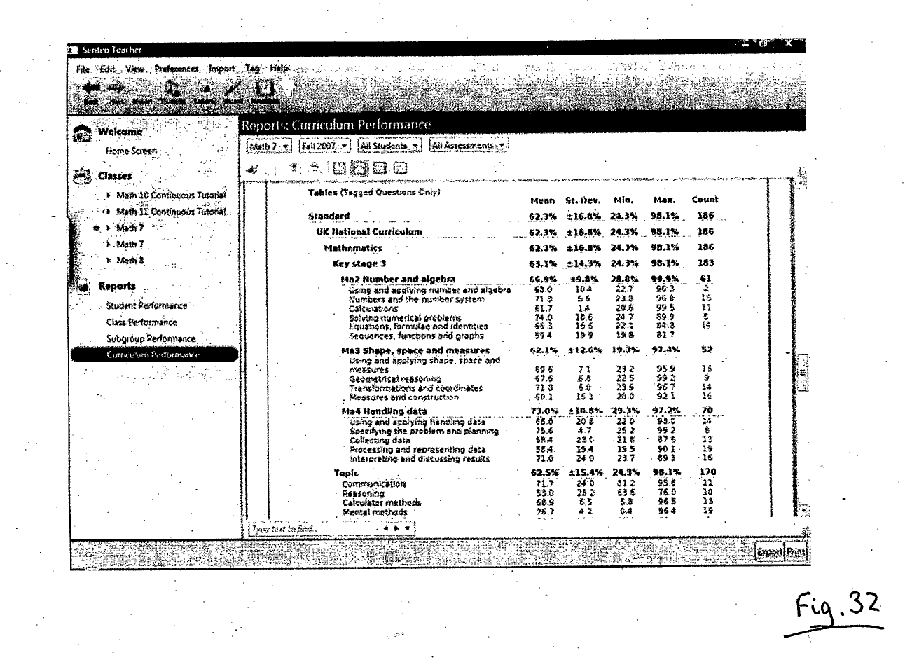

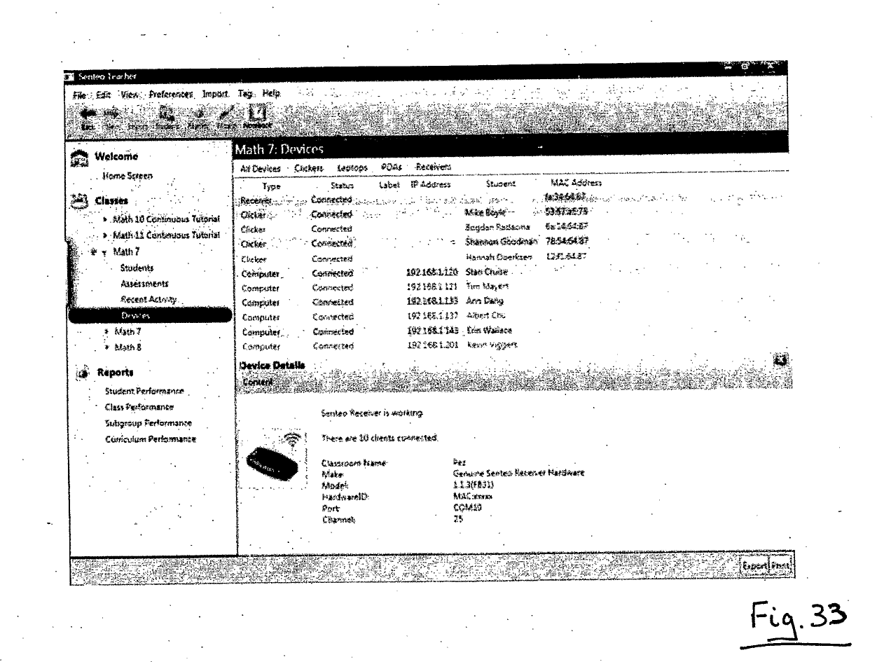

FIG. 31 shows curriculum performance information displayed in the main viewing area 302. As can be seen, a student performance vs. key stages bar chart, a mean student performance vs. topic bar chart and a mean student performance vs. attainment target bar chart are presented. Detailed information concerning student performance in various areas of the curriculum can also be displayed as shown in FIG. 32.

FIG. 33 shows the information displayed in the main viewing area 302 for devices of a selected class. As can be seen each type of device used by students is identified together with their connection status and name together. A diagnostic panel displays the state of the system is also presented. In this example, remote units 62 used by students include a plurality of the illustrated types as identified by the term “clicker” as well as a number of remote computers. Keeping track of the device types used by students, allows student performance to be correlated to device type allowing devices that provide are associated with better or poorer results to be identified.

Although specific information and layout is described above and illustrated, those of skill in the art will appreciate that other reports and information may be presented. Also, the layout of the displayed information may be changed to suit particular environments.

The participant response system configuration specifics described above are exemplary and as will be appreciated by those of skill in the art, variations are possible. For example, the receiver 58 and remote units 62 can communicate according to the ZigBee specification. The receiver 58 and the host computer 52 can communicate over other wired communication links such as RS-232 or Ethernet connections or over a wireless communication link. Alternatively, the receiver 58 may be integrated into the host computer 52 such that the host computer 52 and remote units 62 communicate directly over a wireless communication link via a compatible wireless protocol such as for example Zigbee, Z-Wave, ANT IEEE802.11b/g/n or Bluetooth™.

Although the IWB 54 is described as including an analog resistive touch screen 70, those of skill in the art will appreciate that other types of touch screens, such as for example camera-based, surface acoustic wave, capacitive, electromagnetic etc. touch screens may be used. Alternatively, the questions can be projected onto a non-interactive display surface or delivered to students on handouts. In either case, the instructor interacts with the administration application via the monitor of the host computer 52.

Those of skill in the art will appreciate that although a single classroom employing the participant response system 50 has been shown, in a typical education environment, participant response systems are employed in many, if not all classrooms of the educational institution. Of course, the participant response system 50 may be used in other environments where individuals are required to input responses to be processed.

As described above, the participant response system 50 provides for various advantages that achieve greater operability and user-friendliness. For example, one of the advantages is that all questions and answers are preferably broadcast from the teacher to the students. Logged-in students will thus receive the test and answers. Each student can then work at his/her own pace, and that pace is preferably not controlled by the teacher. Preferably, the teacher can not set software-controlled time limits for responses from either the whole class or from an individual student, so each student can advance at a comfortable pace. Furthermore, since the students preferably can not provide narrative responses, tests will be more efficiently conducted. Another advantage is that the participant response system 50 preferably does not allow the student to operate more than one interactive program at a time. This keeps the student's attention focused on the test at hand. Further, the remote units 62 preferably do not decode a teacher data packet that includes a plurality of characters, a portion of which pertain to different remote units. Also, since the IEEE802.15.4 specification is used, which implements a direct sequence spread spectrum modulation scheme, the communication link from the teacher is not subject to variation in timing between the rising and falling edges of the signal. Thus, the remote units 62 are less susceptible to interference and RF noise accurate information can be transmitted.

Furthermore, the host computer 52 persistently stores partial test results until the entire test is complete. Preferably, an open session between students and teacher is maintained until the test is complete. In no case is information from one test section included in information regarding another test section transmitted to the teacher. This gives each student greater flexibility in responding to the test, and increases the robustness of the communication protocol. In the participant response system 50, preferably, the remote units 62 do not immediately transmit each student keystroke of a multi-character response without waiting for the next keystroke. The entire response is sent when completed. Preferably, the participant response system 50 can not be used in a multi-teacher environment, to avoid confusion in which the teacher has control over the test. Also, when authoring a test, the teacher does not place answers in an answer buffer, does not strip answers from a message, and does not leave a designated blank space in place of each answer or selected character.

In the participant response system 50, the remote units 62 do not store an application-specific text file, and they are not programmed to be used for a plurality of different applications solely by modifying such input text file. Likewise, the remote units 62 do not have any structure or function for identifying a particular one address word (assigned to that particular remote unit) from a list of address words sequentially broadcast by the teacher; nor does the host computer 52 have any structure or function for performing such a broadcast. These provisions allow greater flexibility in the tests the teacher can author and administer in the network communications structure and test distribution architecture.

Although embodiments have been described above with reference to the accompanying drawings, those of skill in the art will appreciate that variations and modifications may be made without departing from the spirit and scope thereof as defined by the appended claims.

What is claimed is:

1. A participant response system comprising:
processing structure running an assessment during which participants are prompted to respond to one or more information requests;
a plurality of remote units communicating with said processing structure, said remote units being used by participants to input responses to information requests and conveying received response data to said processing structure, said processing structure executing a graphical response data analysis tool that processes received response data thereby to generate response performance data in differing levels; and
at least one display device communicating with said processing structure and operable to display graphically said response performance data in one or more of said differing levels.

2. A participant response system according to claim 1 wherein said at least one display device is initially conditioned by said processing structure to present response performance data graphically in a low level form.

3. A participant response system according to claim 2 wherein said at least one display device initially presents response performance data as at least one selectable graphical object, in response to selection of said selectable graphical object, said at least one display device being conditioned by said processing structure to present said response performance data graphically in a high level form.

4. A participant response system according to claim 3 wherein response performance data presented in a high level form is presented in one of a histogram, bar chart, graph and pie chart form.

5. A participant response system according to claim 1 wherein said graphical response data analysis tool comprises a user interface that is displayed on said at least one display device, said user interface comprising a category selection panel in which a list of selectable categories is presented and a main viewing area, said main viewing area presenting response performance data associated with the category selected from said list.

6. A participant response system according to claim 5 wherein one or more of the categories in said list comprise selectable subcategories.

7. A participant response system according to claim 5 wherein said processing structure is responsive to user selected criteria to limit presented response performance data to that meeting said criteria.

8. A participant response system comprising:
processing structure running an assessment during which participants are prompted to respond to one or more information requests; and
a plurality of remote units communicating with said processing structure, said remote units being used by participants to input responses to information requests and conveying received response data to said processing structure, said processing structure executing a graphical response data analysis tool that processes the received response data thereby to generate response performance data, wherein at least one of said remote units processes received response data prior to conveying the response data to said processing structure thereby to distribute the response data processing load.

9. A participant response system according to claim 8 wherein a plurality of remote units processes received response data prior to conveying the response data to said processing structure.

10. A participant response system according to claim 9 wherein said information requests are questions, said processing structure transmitting answer data to remote units that process response data, said remote units using said answer data to grade input responses and conveying the results to said processing structure.

11. A participant response system comprising:
processing structure running an assessment during which participants are prompted to respond to one or more information requests;
a plurality of remote units communicating with said processing structure, said remote units being used by participants to input responses to information requests and conveying received response data to said processing structure, said processing structure executing a graphical tool that maintains a list of the remote units communicating with said processing structure, said list identifying each remote unit by type; and
at least one display device communicating with said processing structure and operable to display graphically said list.

12. A participant response system according to claim 11 wherein said graphical tool monitors the state of said participant response system, the list maintained by said graphical tool also identifying remote unit status.

13. A participant response system according to claim 11 wherein said processing structure generates response performance data based on received response data and correlates the response performance data with remote unit type.
